(19) United States
(12) Patent Application Publication
(10) Pub. No.: US 2025/0143948 A1
(43) Pub. Date: May 8, 2025

(54) LUMBAR TRACTION MASSAGE BED

(71) Applicant: Jiangsu Sintang Health and Technology Co., Ltd, Yancheng City (CN)

(72) Inventor: Chuankui Du, Yancheng City (CN)

(21) Appl. No.: 18/534,726

(22) Filed: Dec. 11, 2023

(30) Foreign Application Priority Data
Nov. 7, 2023 (CN) 202322613411.5

(51) Int. Cl. A61H 1/02

(52) U.S. Cl. CPC A61H 1/0222; A61H 1/0237; A61H 2001/0251; A61H 2201/0142

(57) ABSTRACT

The utility model applies to the field of medical apparatuses, and provides a lumbar traction massage bed. The lumbar traction massage bed includes a bed frame, and further includes a sliding end bed surface and a fixed end bed surface; the fixed end bed surface is fixed at one end of the bed frame, and the sliding end bed surface is connected to the other end of the bed frame in a sliding manner through a sliding rail; and massage portions are arranged at upper portions of both the sliding end bed surface and the fixed end bed surface. The user instructs a leg massage portion or an upper limb massage portion to massage his body through a controller, or the sliding end bed surface can be driven by a motor to move towards a direction away from the fixed end bed surface to achieve a lumbar traction function.

### TECHNICAL FIELD

The utility model belongs to the field of medical apparatuses, in particular to a lumbar traction massage bed.

### BACKGROUND

Existing conventional lumbar traction beds are generally used solely for lumbar traction, and often neglect common symptoms of muscle soreness in patients with lumbar disc prolapse and their requirements for relaxing muscles by massage.

Therefore, it is difficult for the conventional lumbar traction beds to meet usage requirements of household users, because the conventional lumbar traction beds have no other purposes and can only be put aside after a traction purpose is achieved. Therefore, users often need to spend high prices to receive treatment from hospitals or orthopedic clinics.

### SUMMARY

An objective of an embodiment of the utility model is to provide a lumbar traction massage bed, aiming to solve the problem that conventional lumbar traction beds have only a traction function but have no massage function.

The utility model is implemented as follows: A lumbar traction massage bed includes a bed frame, and further includes:

A sliding end bed surface and a fixed end bed surface;

The fixed end bed surface is fixed at one end of the bed frame, and the sliding end bed surface is connected to the other end of the bed frame in a sliding manner through a sliding rail;

Massage portions are arranged at upper portions of both the sliding end bed surface and the fixed end bed surface, and the massage portions on the sliding end bed surface and the fixed end bed surface correspond to lower and upper limb trunks of a user respectively.

In a further technical solution, the sliding end bed surface corresponds to the lower limbs of the user, and the fixed end bed surface corresponds to the upper limb trunk of the user.

In a further technical solution, an electric telescopic linear actuator is mounted at a lower portion of the sliding end bed surface, one end of the electric telescopic linear actuator is connected to the sliding end bed surface, and the sliding end bed surface can be driven away from the fixed end bed surface by extending the electric telescopic linear actuator.

In a further technical solution, the lumbar traction massage bed is further provided with an upper limb fixing assembly used for fixing the upper limb trunk of the user to the fixed end bed surface.

In a further technical solution, the lumbar traction massage bed is further provided with a lower limb fixing assembly used for fixing the lower limbs of the user to the sliding end bed surface.

In a further technical solution, a circuit board is further included, and the circuit board is connected to the massage portions through wires and supplies power to the massage portions.

In a further technical solution, the circuit board is connected to the electric telescopic linear actuator through a wire and supplies power to the electric telescopic linear actuator.

In a further technical solution, a controller is further included, the controller is connected to the circuit board through a wire, the controller is provided with a button, and the button is in communication connection with the circuit board through a wire.

The embodiments of the utility model provide a lumbar traction massage bed, a user can use the lumbar traction massage bed provided by the embodiments of the utility model for separate massage, or use its lumbar traction function alone, or enjoy massage and lumbar traction at the same time. The user instructs the leg massage portion or upper limb massage portion to massage his body through the button of the controller, or the sliding end bed surface can be driven by a motor to move towards a direction away from the fixed end bed surface to achieve a lumbar traction function.

### BRIEF DESCRIPTION OF THE DRAWINGS

FIG. 1 is a front view of a lumbar traction massage bed provided by an embodiment of the utility model;

FIG. 2 is a top view of a lumbar traction massage bed provided by an embodiment of the utility model;

FIG. 3 is a schematic diagram of connection of a circuit board of a lumbar traction massage bed provided by an embodiment of the utility model; and

FIG. 4 is a diagram of left air bags and right air bags of a lumbar traction massage bed provided by an embodiment of the utility model when not inflated and inflated.

In the figures: sliding end bed surface 1, fixed end bed surface 2, bed frame 3, leg air bag 4, left air bag 4-1, right air bag 4-2, upper limb massage air bag 5, sliding rail 6, electric telescopic linear actuator 7, air intake and exhaust hose 8, air pump 9, air valve 10, circuit board 11, transformer 12, controller 13, button 13-1, fixing hook 14, upper limb fixing strap 15, lower limb fixing strap 16.

### DETAILED DESCRIPTION OF EMBODIMENTS

To make the objectives, technical solutions, and advantages of the utility model clearer, the utility model will be further elaborated below with reference to the accompanying drawings and embodiments. It should be understood that the specific embodiments described here are only intended to explain the utility model, but not to limit the utility model.

The specific implementation of the utility model will be described in detail below in conjunction with the specific embodiments.

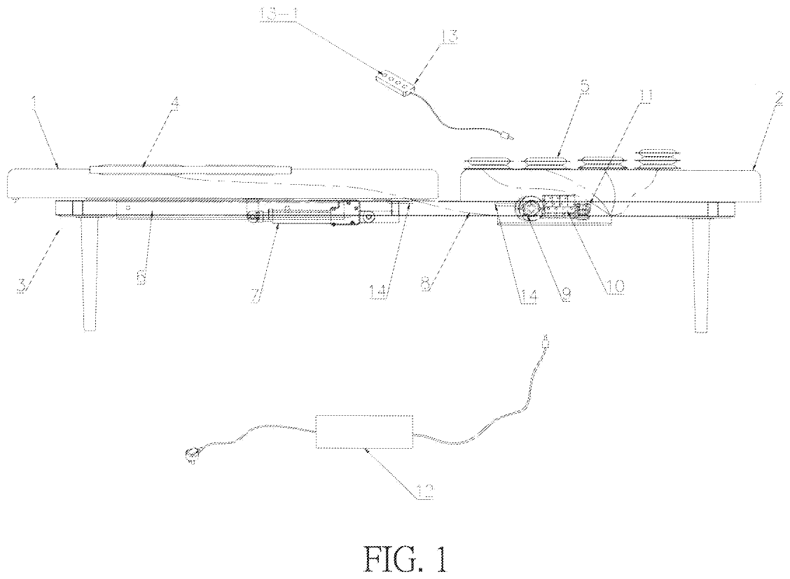

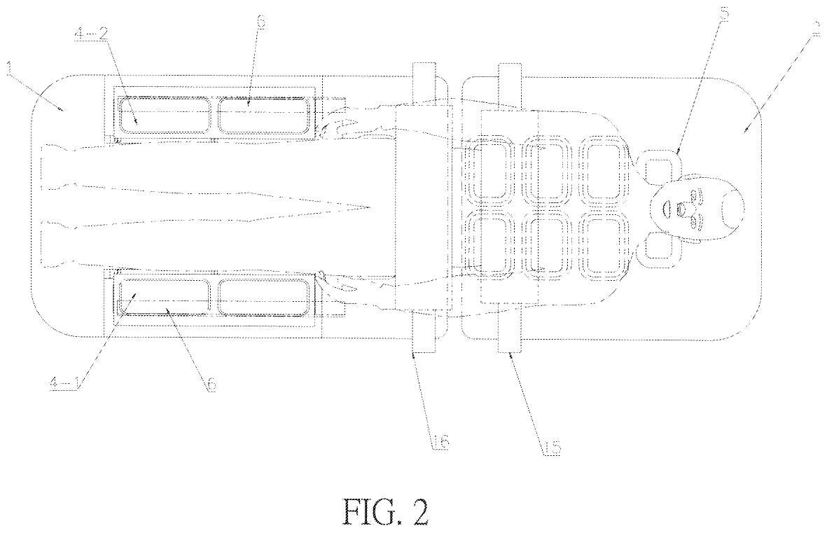

As shown in FIG. 1 and FIG. 2, a lumbar traction massage bed provided by an embodiment of the utility model includes a bed frame 3, and is characterized in that further including:

A sliding end bed surface 1 and a fixed end bed surface 2;

The fixed end bed surface 2 is fixed at one end of the bed frame 3, and the sliding end bed surface 1 is connected to the bed frame 3 in a sliding manner through a sliding rail 6;

Massage portions are arranged at upper portions of both the sliding end bed surface 1 and the fixed end bed surface 2, and the massage portions on the sliding end bed surface 1 and the fixed end bed surface 2 correspond to lower and upper limb trunks of a user respectively.

In the embodiment of the utility model, the sliding end bed surface 1 can move towards a direction away from the fixed end bed surface 2.

As shown in FIG. 2, as a preferred embodiment of the utility model, the sliding end bed surface 1 corresponds to the lower limbs of the user, the fixed end bed surface 2 corresponds to the upper limb trunk of the user, and a junction area between the fixed end bed surface 2 and the sliding end bed surface 1 is located at a lumbar position of the user.

As shown in FIG. 1 and FIG. 2, as a preferred embodiment of the utility model, the massage portions on the sliding end bed surface 1 are leg air bags 4 arranged at an upper portion of the sliding end bed surface 1, the leg air bags 4 are divided into left air bags 4-1 and right air bags 4-2, the left air bags 4-1 correspond to the left leg of the user, and the right air bags 4-2 correspond to the right leg of the user; and the massage portions on the fixed end bed surface 2 are upper limb massage air bags 5 arranged at an upper portion of the fixed end bed surface 2.

As shown in FIG. 1 and FIG. 2, as a preferred embodiment of the utility model, the upper limb massage air bags 5 are arranged on the fixed end bed surface 2 and correspond to the upper limb trunk of the user, the upper limb massage air bags 5 are bulged when inflated and are flat when not inflated, and the upper limb massage air bags 5 massage the upper limbs of the user through inflation and deflation.

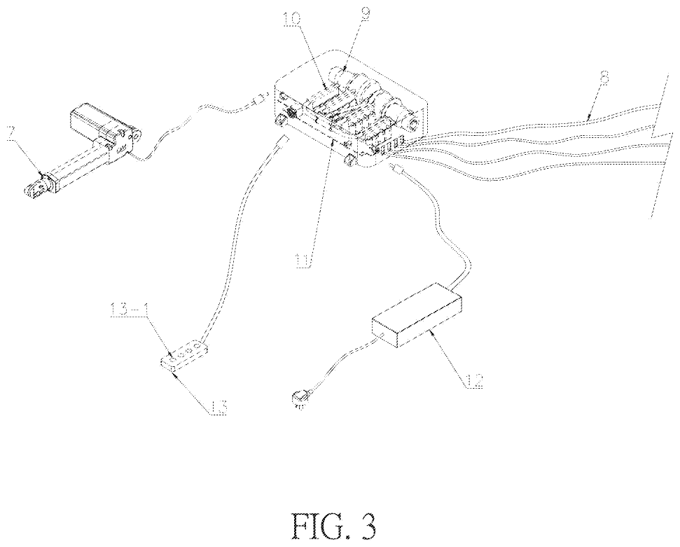

As shown in FIG. 1 and FIG. 3, as a preferred embodiment of the utility model, an air pump 9 and an air valve 10 are mounted on the bed frame 3, the air pump 9 is connected to the air valve 10 through air intake and exhaust hoses 8, the air pump 9 supplies air to the air valve 10 through the air intake and exhaust hoses 8, and the air valve 10 is connected to the left air bags 4-1, the right air bags 4-2, and the upper limb massage air bags 5 through the air intake and exhaust hoses 8. Inflation, holding, and deflation of the left air bags 4-1, the right air bags 4-2, and the upper limb massage air bags 5 are implemented through the closing, opening, and deflating functions of the air valve 10, thereby forming a complete air loop.

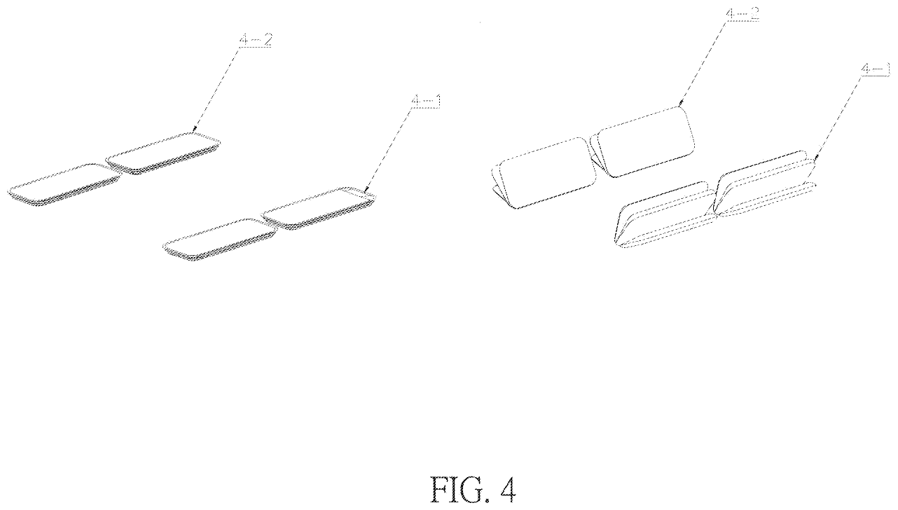

As shown in FIG. 4, the left air bags 4-1 and the right air bags 4-2 each have a three-layer structure, and are flat when not inflated and squeezed layer by layer when inflated. The left air bags 4-1 move towards the left leg of the user when inflated, and the right air bags 4-2 move towards the right leg of the user when inflated, so that the left air bags 4-1 and the right air bags 4-2 clamp the legs of the user.

In the embodiment of the utility model, the user lies flat on the bed surface, with the lower limb trunk corresponding to the sliding end bed surface 1 and the upper limb trunk corresponding to the fixed end bed surface 2. The user places his legs in a clearance between the left air bags 4-1 and the right air bags 4-2. The pelvis of the user is fixed to the sliding end bed surface 1 through a lower limb fixing strap 16, and then the upper limb trunk is fixed to the fixed end bed surface 2 through an upper limb fixing strap 15. The sliding end bed surface 1 is pushed by the extension and retraction of an electric telescopic linear actuator 7 to drive the pelvis of the user to move towards the direction away from the fixed end bed surface 2, thereby achieving lumbar traction. Meanwhile, the left air bags 4-1, the right air bags 4-2, and the upper limb massage air bags 5 are inflated, held, and deflated through the air pump 9, the air valve 10, and the air intake and exhaust hoses 8, to achieve an effect of massaging the lower and upper limb trunks of the user.

As shown in FIG. 1 and FIG. 2, as a preferred embodiment of the utility model, the leg air bags 4 are arranged in pairs opposite to each other to clamp the left and right legs of the user respectively, the leg air bags 4 are bulged when inflated and are flat when not inflated, and positions of the leg air bags 4 correspond to the legs of the user.

As shown in FIG. 1 and FIG. 2, as a preferred embodiment of the utility model, a clearance is reserved between the left air bags 4-1 and the right air bags 4-2, and the clearance is suitable for placing the legs of the user therein.

As shown in FIG. 1, as a preferred embodiment of the utility model, the electric telescopic linear actuator 7 is mounted at a bottom portion of the sliding end bed surface 1, one end of the electric telescopic linear actuator 7 is connected to the sliding end bed surface 1, and the sliding end bed surface 1 can be driven away from the fixed end bed surface 2 by extending the electric telescopic linear actuator 7.

In the embodiment of the utility model, the electric telescopic linear actuator 7 extends to drive the sliding end bed surface 1 to move towards the direction away from the fixed end bed surface 2; and the electric telescopic linear actuator 7 retracts to drive the sliding end bed surface 1 to move towards a direction near the fixed end bed surface 2 for resetting.

As shown in FIG. 1 and FIG. 2, as a preferred embodiment of the utility model, an upper limb fixing assembly used for fixing the upper limb trunk of the user to the fixed end bed surface 2 is arranged on the fixed end bed surface 2, and the upper limb fixing assembly includes an upper limb fixing strap 15 and a fixing hook 14 arranged on the fixed end bed surface 2 and the bed frame 3;

A lower limb fixing assembly used for fixing the lower limbs of the user to the sliding end bed surface 1 is arranged on the sliding end bed surface 1, and the lower limb fixing assembly includes a lower limb fixing strap 16 and a fixing hook 14 arranged on the sliding end bed surface 1 and the bed frame 3.

In the embodiment of the utility model, the upper limb trunk of the user is fixed to the fixed end bed surface 2 through the upper limb fixing strap 15, and the pelvis of the user can be fixed to the sliding end bed surface 1 through the lower limb fixing strap 16. The electric telescopic linear actuator 7 extends to drive the sliding end bed surface 1 to move towards the direction away from the fixed end bed surface 2, the sliding end bed surface 1 pulls the pelvis of the user through the lower limb fixed strap 16 to move towards the direction away from the fixed end bed surface 2 together with the sliding end bed surface 1, and the upper limb fixed strap 15 fixes the upper limb trunk of the user to the fixed end bed surface 2, so that the pelvis and lower limbs of the user are kept away from the upper limb trunk of the user, the lumbar spine of the user is elongated, and a lumbar traction effect is achieved.

As shown in FIG. 3, as a preferred embodiment of the utility model, a circuit board 11 is further included, the circuit board 11 is connected to the air pump 9 and the air valve 10 through wires and supplies power to the air pump 9 and the air valve 10, and the circuit board 11 is connected to the motor 7 through a wire and supplies power to the motor 7.

In the embodiment of the utility model, the circuit board 11 pre-stores a working program, and controls the air pump 9 to pump air or controls the air supply and deflation of the air valve 10 by powering on or powering off the air pump 9 or the air valve 10 according to the preset program, thereby achieving the inflation, holding and deflation of the left air bags 4-1, the right air bags 4-2, and the upper limb massage air bags 5. The circuit board 11 pre-stores the working program, and controls the electric telescopic linear actuator 7 to extend or retract by powering on the electric telescopic linear actuator 7 according to the preset program.

As shown in FIGS. 1-3, as a preferred embodiment of the utility model, a transformer 12 is further equipped, and the transformer 12 is connected to an external power supply. The transformer 12 can be connected to an external power socket and can convert a strong voltage between 110V and 230V of the external power supply into a safe voltage below 36V. The transformer 12 is connected to the circuit board 11 through a wire and supplies power to the circuit board 11, and the circuit board 11 is connected to the air pump 9 and the air valve 10 through wires and supplies power to the air pump 9 and the air valve 10, thereby forming a complete power supply circuit.

As shown in FIGS. 1-3, as a preferred embodiment of the utility model, a controller 13 is further included, the controller 13 is connected to the circuit board 11 through a wire, the controller 13 is provided with a button 13-1, and the button 13-1 is in communication connection with the circuit board 11 through a wire, thereby controlling the circuit board 11 by controlling the button 13-1.

In the embodiment of the utility model, the user activates the traction function of the utility model through the button 13-1 of the controller 13 and sets a traction distance by controlling the button 13-1, the circuit board 11 performs traction on the lumbar spine of the user according to the preset working program, then the sliding bed surface 1 is reset, and multiple times of traction on the lumbar spine of the user is implemented after repeated cycles;

The user activates the massage function of the utility model through the button 13-1 of the controller 13, instructs the circuit board 11 to run according to the preset massage program, controls the air pump 9 to pump air and controls the air supply and deflation of the air valve 10, thereby achieving the inflation, holding, and deflation of the left air bags 4-1, the right air bags 4-2, and the upper limb massage air bags 5, and massaging the lower and upper limbs of the user;

During the lumbar traction, the legs, buttock, waist and back of the user can also be massaged through the air bags, so the usage of a whole family can be satisfied. Even members in the family who do not require lumbar traction can still use the massage function alone, so the massage bed is very convenient.

The foregoing descriptions are merely preferred embodiments of the utility model, and are not intended to limit the utility model. Any modification, equivalent replacement, improvement, and the like made within the spirit and principle of the utility model shall fall within the scope of protection of the utility model.

I claim:

1. A lumbar traction massage bed, comprising a bed frame, characterized in that further comprising:
a sliding end bed surface and a fixed end bed surface,
wherein the fixed end bed surface is fixed at one end of the bed frame, and the sliding end bed surface is connected to the other end of the bed frame in a sliding manner through a sliding rail; and
massage portions are arranged at upper portions of both the sliding end bed surface and the fixed end bed surface, and the massage portions on the sliding end bed surface and the fixed end bed surface correspond to lower and upper limb trunks of a user respectively.

2. The lumbar traction massage bed according to claim 1, characterized in that the sliding end bed surface corresponds to the lower limbs of the user, and the fixed end bed surface corresponds to the upper limb trunk of the user.

3. The lumbar traction massage bed according to claim 1, characterized in that an electric telescopic linear actuator is mounted at a lower portion of the sliding end bed surface, one end of the electric telescopic linear actuator is connected to the sliding end bed surface, and the sliding end bed surface can be driven away from the fixed end bed surface by extending the electric telescopic linear actuator.

4. The lumbar traction massage bed according to claim 1, characterized in that the lumbar traction massage bed is further provided with an upper limb fixing assembly used for fixing the upper limb trunk of the user to the fixed end bed surface.

5. The lumbar traction massage bed according to claim 1, characterized in that the lumbar traction massage bed is further provided with a lower limb fixing assembly used for fixing the lower limbs of the user to the sliding end bed surface.

6. The lumbar traction massage bed according to claim 3, characterized in that further comprising a circuit board, wherein the circuit board is connected to the massage portions through wires and supplies power to the massage portions.

7. The lumbar traction massage bed according to claim 6, characterized in that the circuit board is connected to the electric telescopic linear actuator through a wire and supplies power to the electric telescopic linear actuator.

8. The lumbar traction massage bed according to claim 3, characterized in that further comprising a controller, wherein the controller is connected to the circuit board through a wire, the controller is provided with a button, and the button is in communication connection with the circuit board through a wire.
